(19) United States
(12) Patent Application Publication
(10) Pub. No.: US 2012/0252397 A1
(43) Pub. Date: Oct. 4, 2012

(54) METHOD, SYSTEM AND APPARATUS FOR RESUMPTION OF NORMAL SERVICE

(75) Inventor: Swaroop Sampath Kumar, Singapore (SG)

(73) Assignee: PANASONIC CORPORATION, Osaka (JP)

(21) Appl. No.: 13/516,144

(22) PCT Filed: Dec. 18, 2009
(86) PCT No.: PCT/JP2009/007008

§ 371 Date: Jun. 14, 2012

(51) Int. Cl. H04W 36/14; H04W 4/22

(52) U.S. Cl. 455/404.1; 455/440

(57) ABSTRACT

A system of normal service resumption comprising of a UE that is currently behaving as emergency attached after receiving an limited service indication from the network, sends a behaviour change request message when the UE enters a new tracking area with a tracking area identity that is not included in the forbidden list. The network node accepts the behaviour change request when it receives a behaviour change request message from a UE that is currently behaving as emergency attached and sending the behaviour change request message from an area wherein the UE can obtain normal service. Subsequently, the said UE and network node consider the UE to be normally attached after the behaviour change request has been accepted.

### TECHNICAL FIELD

The present invention pertains to the field of radio communications. The invention applies to cases when the mobile phone is currently progressing with a service that is limited in scope and aims to get back to normal service.

### BACKGROUND ART

In current mobile network node 20s, any user can have subscription limitations as to where and what services might available to him. For example, a user might be prevented from accessing a CSG (closed subscriber group) cell or the user is restricted from making a normal voice call in a forbidden PLMN. Or for example, if there is no UICC in the UE (user equipment), the UE cannot get access to the service the user has subscribed to.

But according to the laws in some countries, a user must be able to attempt an emergency call irrespective of subscription limitations: In such cases, the UE and the network need exceptional handling of this case. That is, the network needs to allow the emergency call to occur. In this case, most operators would prefer restrict the user to only attempt emergency calls.

Another basic requirement in SAE is that the UE must at least have one bearer context to stay registered to the network node. At any point of time, if the UE does not have any bearer contexts left, it must consider itself to be deregistered from the network node. After this it may possibly re-attach.

The problem to solve for emergency calls is how to restrict the usage of the network node strictly for emergency calls and yet allow normal service as soon as possible to a user when conditions are in line with the user's subscription.

The prior art identified is the solution specified in the last specification of 23.401v9.2.0. To allow a UE to perform an emergency call, the UE uses an “emergency” indication in the attach type when attempting a call. That is, when an emergency call is triggered by the user, and UE realizes that it is in an area where it cannot get normal service, it attempts an attach with the attach type IE (informational element) indicating emergency. The network can recognize the reason for attach by the UE and if local laws require allowing emergency calls despite subscription restrictions, the network proceeds with allowing the registration. Along with the attach request message, the UE can also request for emergency bearers. The network allows the use of emergency bearers only for the emergency call. No other data is to be sent on these bearers. In fact, the UE should not attempt to connect to any other PDN nor make any requests to make any modification to session parameters. The network also provides a timer value (periodic TAU timer) to the UE which the UE should use after going to the idle mode. Once the bearers have been established., the UE may initiate the emergency call. During the length of the emergency call, the UE stays in connected mode. After the emergency call ends, the UE returns to idle mode after various inactivity timers run and the RRC connection is released. Now, the UE runs the timer given to the UE by the network node during the attach procedure. While the timer runs, the UE can only attempt emergency calls. After expiry of the timer, the UE should consider itself deregistered from the network. So, generally, an UE when emergency attached has the following exception behaviours, which we can term as emergency attached behaviour. First, the UE must not perform any UE initiated session modification requests. Second, while the TAU periodic timer is running in the UE, the UE shall not attempt any other call other than another emergency call. Third, the UE shall consider itself deregistered from the network after the TAU periodic timer expires.

Another case when the UE might have to follow the emergency attached behaviour despite not having attached with attach type “emergency” is when a normally attached UE moves from an area where it is allowed to an area where it is restricted. A normally attached UE will have at least one other non-emergency bearer before it attempts an emergency call. When the UE crosses such a border, the basic behaviour is to perform a tracking area update. The network realizing that the UE is not in an allowed area deactivates the non-emergency bearers of the UE. The UE after this shall consider itself to be emergency attached and behave as an emergency attached UE.

This document targets a problem scenario that may occur in the prior art solution identified. The situation targeted is when a UE is behaving as an emergency attached UE and the UE or the user is from a restricted area to an allowed area while an emergency call is progressing. A UE can be emergency attached either when the UE has performed an emergency attach or when the UE has performed a normal attach but moved into a forbidden area and a result had its non-emergency bearers deactivated. The prior art solution in this case will work as follows. If the user moves from the restricted area to an allowed area, the UE will continue to behave as if emergency attached despite being in an allowed area. Further, after the user completes the call, inactivity timers will run in the network. After the inactivity timers expire the S1 and subsequently the RRC connection will be released. After the release, the UE will run the TAU timer. After the TAU timer expires, the UE will move to deregistered state after which the UE will perform cell reselection, PLMN selection and subsequently perform another attach to the network. From the end of the emergency call to when the UE can attach again, the UE continues to be restricted to only emergency calls. This time period can be calculated by the sum of the inactivity timer at the PDN-GW, the TAU timer running in the UE, the time taken for cell selection and re-attach and the round trips needed for attach procedure. This time can range from a few minutes to tens of minutes mainly dependent on value of the timers configured by the operator. This limitation is particularly severe in times of emergency, particularly when the user has every right, as he in an allowed area, and need to make a normal call and contact friends and family. This invention aims to correct this problem.

### CITATION LIST

### Non Patent Literature

[NPL 1]

3GPP TS 23.401v9.2, “General Packet Radio Service (GPRS) enhancements for Evolved Universal Terrestrial Radio Access Network node 20 (E-UTRAN) access”

[NPL 2]

3GPP TS 24.301 v9.0.0, “Non-Access-Stratum (NAS) protocol for Evolved Packet System (EPS)”

### SUMMARY OF INVENTION

Once the UE is emergency attached, the UE continues to monitor the tracking area changes. The UE shall check if a new TA is not in the forbidden list. If the new TA is not in the forbidden list, at least according to UE's information, the UE will be in a normal area. The UE then initiates a state change request message to the network. The network checks the UEs subscription data and if the UE is indeed in an allowed area, the network accepts the state change request. Subsequently, the network and UE change the state of the UE as normally attached. As the UE now is normally attached, the UE or network node in order to enable normal services may proceed with non-emergency bearer establishment.

### BRIEF DESCRIPTION OF DRAWINGS

FIG. 1 is a diagram illustrating the preferred apparatus of the UE.

FIG. 2 is a diagram illustrating the preferred apparatus for the Network node.

FIG. 3 is a diagram illustrating the prior art method of changing behaviour from normal to emergency attached behaviour.

FIG. 4 is a diagram illustrating the preferred method of changing behaviour from normal to emergency attached behaviour.

FIG. 5 is a diagram illustrating the prior art method of resumption of normal service for an emergency attached UE 10.

FIG. 6 is a diagram illustrating the preferred method of resumption of normal service for an emergency attached UE 10.

FIG. 7 is a diagram illustrating the preferred steps for the UE 10 to follow in order to resume normal service.

### DESCRIPTION OF EMBODIMENTS

Hereafter, the UE 10 or Network node 20 refers to any device with networking capabilities. The specification makes the assumption that it is entirely possible to implement these functionalities in different devices and yet perform the inventive mechanisms mentioned in this specification. As a non-limiting example, it may entirely be possible for a part of the functionality of the Network node 20 to be implemented in the MME or SGSN or GGSN or Packet Gateway or eNB as specified in current 3GPP SAE release-8 architecture. A tracking area is a term used to indicate a region whose boundaries are determined by the network node 20. It is assumed that in each area, the UE 10 is made aware of the tracking area it is based on broadcasts. Other terms could be used by persons skilled in the art to mean the same, non-limiting examples being location area, routing area, etc.

This invention addresses resumption from limited service to normal service. It focuses on emergency service as a limited service as emergency is the defined limited service today. But, the usage of the term “emergency” should not limit the scope of limited service. The invention should be equally applicable to any limited service. For example, usage of emergency-bearer or emergency-indication or emergency service behaviour can be viewed as limited bearers, limited service indication or limited service behaviour respectively.

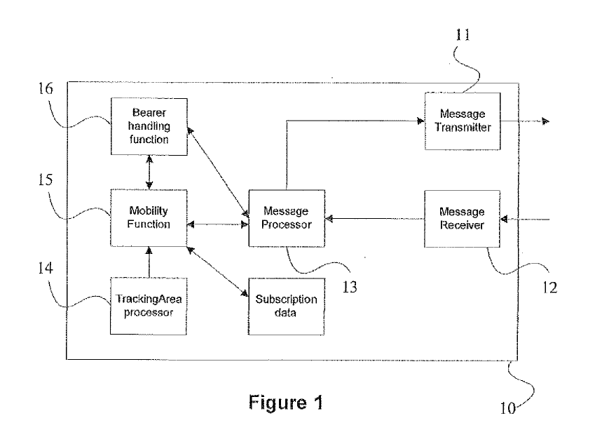

FIG. 1 describes the apparatus of the UE 10 in the preferred embodiment of the invention. The UE 10 has a message receiver 12 that is used to receive incoming messages from the network node 20 and provide to the message processor 13 for further processing. The UE 10 has a message transmitter 11 that is used to transmit the messages the UE 10 sends out to the network node 20. The main processing unit in the UE 10 is the message processor 13. The message processor is the function that parses and analyzes whether a message is meant for mobility function 15 or the bearer handling function 16. The mobility function 15 is the function that manages the mobility and subscription related functions of the UE 10. It analyzes the changes in tracking area and acts accordingly. The tracking area related triggers are provided by the Tracking Area Processor 14. The mobility function checks the subscription support of a tracking area or PLMN using the subscription data 13. The subscription data 13 is a list of allowed and restricted areas and PLMNs that the UE 10 is allowed to get normal service. The mobility function 15 also determines the state of a UE 10 depending on the location of the UE 10. Based on subscription data it has or provided by the network node 20, the UE 10 can be in limited service or normal service state. The behaviour of the mobility function is restricted while in limited service. For example, the UE 10 can only initiate emergency calls in limited service. According to this invention, if the UE 10 is currently behaving as emergency attached, and moves into a tracking area where the subscription data states as an allowed area, the Mobility function 15 may initiate a request the Network node 20 to change state to normal behaviour. Once the state change request has been granted by the network node 20, the mobility function can request the bearer handling function 16 to resume normal services and obtain non-emergency bearers. The mobility function also processes different ways of moving to emergency attached behaviour. One method is if the UE 10 is currently in a restricted area, the UE 10 may initiate an attach with attach type “emergency”. If successful, the mobility function 15 makes the UE 10 behave as an emergency attached UE 10. Another method is if the UE 10 is normally attached but moves into an area that is restricted. In this case, the mobility function 15 is informed by the network node 20 that the UE 10 needs to change its behaviour to emergency attached. The network node 20 may inform the UE 10 in two ways. The network node 20 may inform by deactivating the non-emergency bearers and subsequently the bearer handling function notices that all non-emergency bearers have been deactivated. In this case, the bearer handling function 16 informs the mobility function 15 to change the UE 10 behaviour to emergency attached. Another method of informing the UE 10 according to the invention is when the network node 20 provides an indication to the tracking area update message that the UE 10 is in a restricted area.

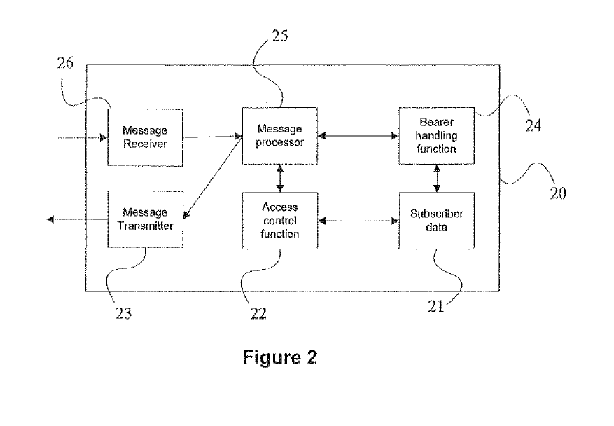

FIG. 2 describes the apparatus of the Network node 20. For simplicity, all functions are being shown in a single device. The Network node 20 also has a message transmitter 23 and a message receiver 26 that are used to transmit and receive messages to the UE 10. The message processor 25 is the processing unit of the Network node 20. The main function of the message processor is to maintain the mobility of the UE 10. It interacts with the access control function 22 which is responsible for authorization of UE 10's actions. The access control function 22 interacts with the subscriber data 21 to check for subscription info of the user, and uses this info to judge the validity of UE 10's behaviour. The message processor 25 also parses messages and routes the message to the end function responsible for processes a message. It provides session related messages to bearer handling function 24. The bearer handling function 24 is aware of the UE 10's bearer contexts. It manages the establishment, modification and deactivation of bearers. According to one of the aspects of this invention, when the UE 10 that is normally attached and currently performing an emergency call has requested a tracking area update from a restricted area, the access control function 22 provides an indication in the tracking area accept message that the UE 10 is in a restricted area and change its behaviour to emergency attached. According to another preferred aspect of this invention, when an emergency attached UE 10 sends a tracking area update request from an allowed area, the access control function 22 indicates to the UE 10 that the UE 10 may change its behaviour to normal behaviour.

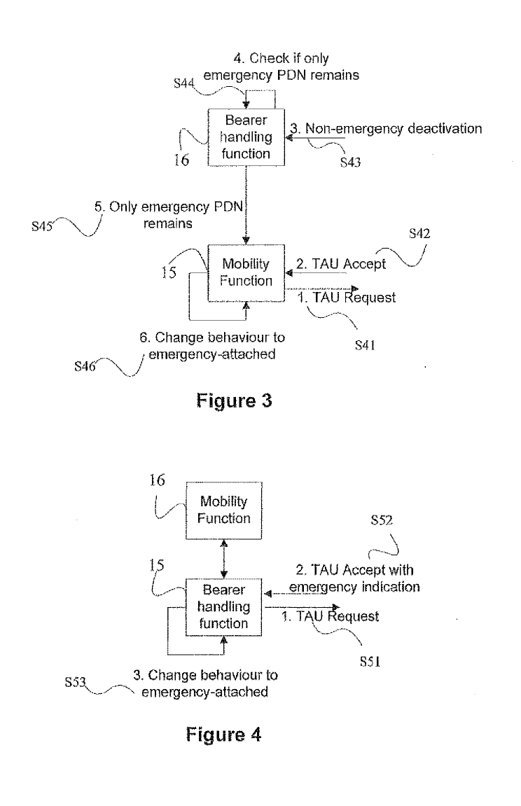

FIG. 3 describe the prior art method of changing behaviour from normal to emergency attached behaviour. The situation assumed is when a normally attached performing an emergency call enters a restricted area. The UE 10 therefore sends a tracking area update message, shown in step S41, as the TA will not in the TAI list. The Network node 20 receives this message and checks that the UE 10 is sending a TAU from a restricted area. The Network node 20 then decides to restrict the UE 10 to only perform emergency service. To enable this, it first completes the tracking area procedure. For this, it sends the tracking area accept as shown in step S41 and the UE 10 is expected not to add this TA either to the TAI list nor the forbidden list. The network node 20 then initiates the deactivation of non-emergency bearers as shown in step S43. The bearer handling function 16 in the UE 10 then deactivates as requested and checks if the only PDN left is the emergency PDN. This is shown in Step S44. The bearer handling function 16 then updates the mobility function 15 as shown in step S45 informing that UE 10 has no other bearer except emergency bearers. In this case, the mobility function 15 changes it future behaviour to emergency attached behaviour as shown in step S46. Once the UE 10 changes its behaviour to emergency attached, the UE 10 will not make any session related requests. It will also attempt only emergency calls while still registered. It will also deregister once the TAU timer has expired. One of the problems with the current art approach is that there is a delay between when the Network node 20 decides that the UE 10 is not in restricted area to when the UE 10 actually changes its behaviour in step S41. Another problem is that this method introduces impacts to bearer handling function 16 and further impacts to the interaction with the mobility function 15. Interactions must be avoided as much as possible to minimize the cost of development.

FIG. 4 illustrates the prior art method of resumption of normal service for an emergency attached UE 10. Here, the normally attached UE 10 with emergency session in progress requests for a tracking area update as shown in step S51. The situation assumed is when a normally attached performing an emergency call enters a restricted area. The UE 10 therefore sends a tracking area update message, shown in step S41, as the TA will not in the TAI list. The Network node 20 receives this message and checks that the UE 10 is sending a TAU from a restricted area. The Network node 20 then decides to restrict the UE 10 to only perform emergency service. To enable this, it completes the tracking area procedure while providing an indication to the UE 10 that the UE 10 is in a restricted area. This way, the UE 10 updates its behaviour without any delay or impact to interaction with bearer handling function 16.

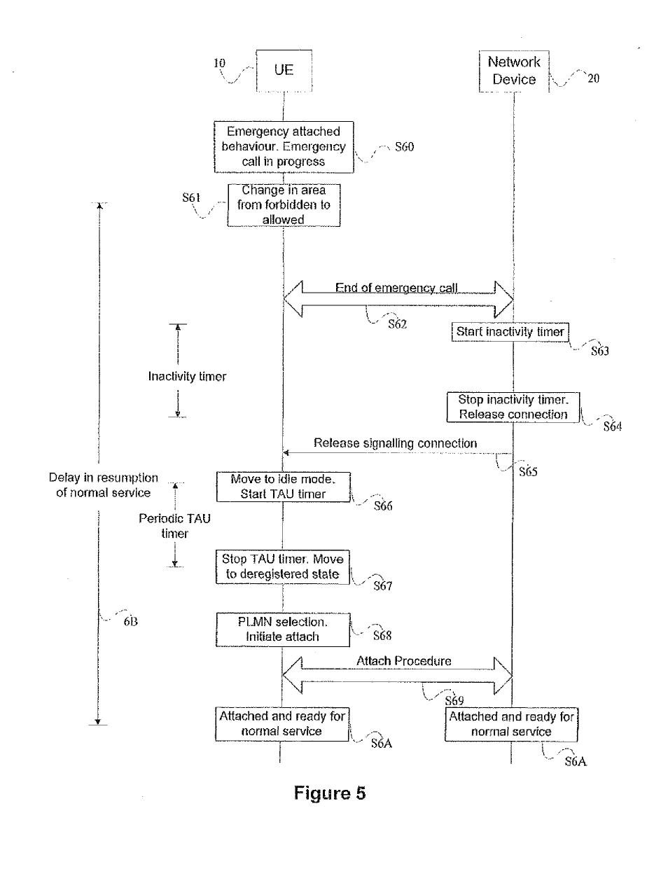

FIG. 5 is a diagram illustrating the prior art method of resumption of normal service for an emergency attached UE 10. The situation assumed at the start of the procedure is that the UE 10 currently behaves as if emergency attached and an emergency call is in progress as shown in step S60. The UE 10 in such a situation can be assumed to be in connected mode. At step S61, UE 10 moves from a forbidden area into an allowed area. The UE 10 does not do anything if the new TA is in the TAT list. If the new TA is not in the TAI list, a tracking area update is performed but this is as per normal tracking area procedures and does not impact the behaviour of the UE 10. So for simplicity, this procedure is not shown here. After a certain time, it is assumed that the emergency call ends as shown in Step S62. When the emergency call ends, the Network node 20 usually deactivates the GBR or guaranteed bit rate bearers leaving only the non-GBR bearers active. Once the GBR bearers are deactivated, the Network node 20 starts an inactivity timer as shown in Step S63. The inactivity timer is usually implemented in the base station of a 3GPP system and is configured by the operator. The UE 10 remains in connected mode until the inactivity timer expires as shown in step S64. After the expiry of the inactivity timer, the Network node 20 releases the signaling connection as shown in step S65. After receiving the request to release the signaling function, the UE 10 changes to idle mode and starts the periodic TAU timer as shown in step S66. After the periodic timer expires, the UE 10 moves to deregistered state as shown in step S67. Once in deregistered state, cell reselection and PLMN selection procedures occur that will result in the UE 10 performing an attach procedure as shown in Step S69, as the UE 10 will currently be in an allowed area. As part of the attach procedures, the UE 10 will also get default PDN connectivity. This is when the UE 10 is ready for normal service as shown in Step S6A. The problem as discussed earlier is that there is a large time gap as shown in 6B consisting of the sum of the inactivity timer, the periodic timer and multiple round trips before the UE 10 can resume communications. This can easily be from a few minutes to tens of minutes where normal calls cannot be performed. This is not good from a customer point of view who has paid for his mobile service only, particularly in an emergency situation.

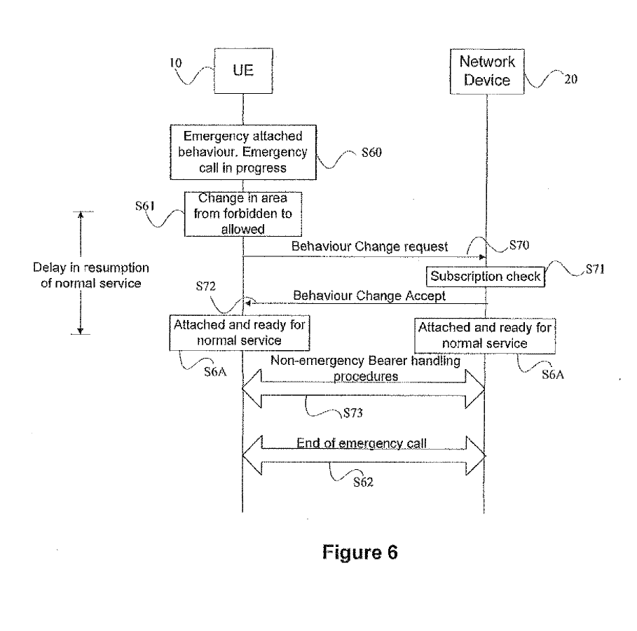

FIG. 6 is a diagram illustrating the preferred method of resumption of normal service for an emergency attached UE 10. The situation assumed at the start of the procedure is that the UE 10 currently behaves as if emergency attached and an emergency call is in progress as shown in step S60. When the UE 10 moves from a restricted area to a normal area, the UE 10 will detect a change of TAI. It will judge that the area is a normal area as the TAI will not be in the forbidden list. At, this point, the UE 10 will send a message of behaviour change request as shown in Step S70. The Network node 20 receives this message and realizes that the UE 10 thinks that the UE 10 in an allowed area. It subsequently does a subscription check as shown in step S6A to verify that the UE 10 is indeed in an allowed area. After checking that the UE 10 is indeed in an allowed area, the Network node 20 accepts that the UE 10 can change its behaviour to normal behaviour as shown in Step S72. Subsequently, after sending and receiving of this message by the Network node 20 and the UE 10 respectively, both nodes change the UE 10's behaviour as normal behaviour as shown in step S6A. After this, the UE 10 initiates the non-emergency bearer handling procedures to resume normal services. The network node 20 may also initiate the establishment of non-emergency bearers. As can be seen here, the only delay in resumption of normal service is between step S61 and step S6A which is a round trip delay. This is the minimum delay possible compared to implicit change in behaviour. Implicit change while possible will not be the optimal solution as the UE 10 only knows that the TAI is not in the forbidden list but does not know whether the TAI may not be allowed by the network node 20. That is, the forbidden list in the UE 10 may not be an exhaustive list.

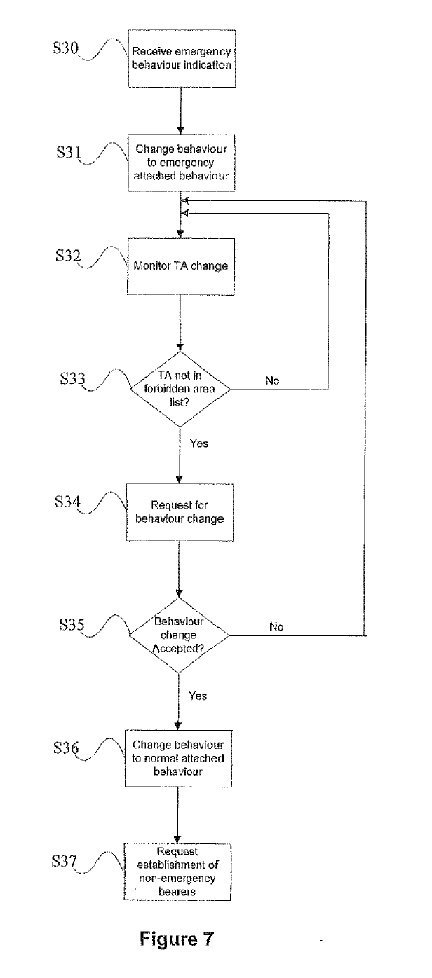

FIG. 7 is the preferred embodiment of the invention for the preferred steps for the UE 10 to follow in order to resume normal service. In step S30, the UE 10 receives an indication from the network node 20 that the UE 10 has to behave as if emergency attached. This can happen either when the UE 10 performs emergency attach or a normally attached UE 10 is asked by the network node 20 to move to emergency attached behaviour. The network node 20 may ask the UE 10 to move emergency attached behaviour by either deactivating all the non-emergency bearers or by indicating explicitly during the TAU procedures. The UE 10 behaviour changes to that of an emergency attached behaviour as shown in Step S31. Now as shown in Step S32, the UE 10 monitors the change of TA and waits for whether a new TA is entered with a TAI that is not present in the forbidden list. When a new TA is entered, the UE 10 cheeks whether the TAI of the new TA is present in the forbidden list. If not, the UE 10 continues to monitor as in step S32. If the TAT is indeed not present in the TAI list, at least according to information available to the UE 10, the UE 10 is in a normal area. At this point, it requests the network node 20 node 10 for a change of behaviour as shown in step S34. In step S35, the UE 10 checks if the behaviour change request has been accepted by the Network node 20. If it has been accepted, the UE 10 changes its behaviour to normal attached behaviour as shown in Step S36. Subsequent to this, it may initiate establishment of non-emergency bearers as shown in Step S37.

Here a few non-limiting examples of the types of messages that could be used to achieve the steps in FIG. 7. The emergency behaviour indication provided by the Network node 20 can either be an attach accept response to an emergency attach or deactivation of non-emergency bearers without indication in TAU Accept or deactivation of non-emergency bearers with TAU accept with an indication that UE 10 is in a restricted area. The Request for behaviour change message can be a TAU without any explicit indication. It can also be a TAU with explicit indication by the UE 10 that it the TAU is for a request for behaviour change to normal attached. It can also be a PDN connectivity request message by the UE 10 to connect to a non-emergency PDN. In this case, it might be violating the principle of emergency attached behaviour. But the cost of this message is minimal as the network node 20 can always reject this message. Using PDN connectivity request message straight away would also avoid the cost of a round trip message. The response to the request for behaviour change message can be provided by a TAU Accept message without any indication. A TAU Accept without any explicit indication can be used when the indication used by the network node 20 to inform the UE 10 of its change to emergency attached in Step S30 is a TAU with an explicit indication. Another method for the network node 20 to respond to a request for behaviour change is to just accept the TAU request and follow up with a EPS create default bearer request message that will straight away initiate a default bearer for the UE 10. Any of these possibilities can be used and standardized.

According to another embodiment of this invention, a normally attached UE 10 becomes an emergency attached UE 10 when its bearer contexts are deactivated after a tracking area update procedure. The UE 10 then monitors the change in tracking area identity if any. If to new tracking area identity is detected and the tracking area is not in the forbidden list, the UE 10 may initiate a tracking area update request message. The Network node 20 then checks if the UE 10 is allowed to receive normal service the area. If so, the network node 20 sends a tracking area update accept message with an indication that the UE 10 can change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when its bearer contexts are deactivated after a tracking area update procedure. The UE 10 then monitors the change in tracking area identity if any. If a new tracking area identity is detected and the tracking area is not in the forbidden list, the UE 10 may initiate a tracking area update request message. The Network node 20 then checks if the UE 10 is allowed to receive normal service the area. If so, the network node 20 after completion of the tracking area procedures initiates the bearer establishment for non-emergency PDN. When the UE 10 receives this message, the UE 10 and network node 20 may consider the UE 10's behaviour to be emergency attached.

According to another embodiment of this invention, a normally attached UE 10 becomes an emergency attached UE 10 when its bearer contexts are deactivated after a tracking area update procedure. The UE 10 then monitors the change in tracking area identity if any. If the new tracking area identity is detected and the tracking area is not in the forbidden list, the UE 10 may initiate a tracking area update request message and provide an indication that it is requesting for change of UE 10 behaviour from emergency attached to normal attached. The Network node 20 then checks if the UE 10 is allowed to receive normal service the area. If so, the network node 20 after completion of the tracking area procedures initiates the bearer establishment for non-emergency PDN. When the UE 10 receives this message, the UE 10 and network node 20 may consider the UE 10's behaviour to be emergency attached.

According to another embodiment of this invention, a normally attached UE 10 becomes an emergency attached UE 10 when its bearer contexts are deactivated after a tracking area update procedure. The UE 10 then monitors the change in tracking area identity if any. If the new tracking area identity is detected and the tracking area is not in the forbidden list, the UE 10 may initiate a tracking area update request message and provide an indication that it is requesting for change of UE 10 behaviour from emergency attached to normal attached. The Network node 20 then checks if the UE 10 is allowed to receive normal service the area. If so, the network node 20 sends a tracking area update accept message with an indication that the UE 10 can change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when its bearer contexts are deactivated after a tracking area update procedure. The UE 10 then monitors the change in tracking area identity if any. If the new tracking area identity is detected and the tracking area is not in the forbidden list, the UE 10 may initiate a initiate bearer establishment for non-emergency PDN. The Network node 20 then checks if the UE 10 is allowed to receive normal service the area. If so, the Network node 20 initiates the setup of default bearer. Once the default bearer is setup, the UE 10 and network node 20 consider the UE 10 to be normally attached.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If a new tracking area identity is detected and the tracking area is not in the forbidden list, the UE 10 may initiate a tracking area update request message. The Network node 20 then checks if the UE 10 is allowed to receive normal service the area. If so, the network node 20 sends a tracking area update accept message that informs the UE 10 to change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If a new tracking area identity is detected and the tracking area is not in the forbidden list, the UE 10 may initiate a tracking area update request message. The Network node 20 then checks if the UE 10 is allowed to receive normal service the area. If so, the network node 20 sends a tracking area update accept message with an indication that informs the UE 10 to change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If a new tracking area identity is detected and the tracking area is not in the forbidden list, the UE 10 may initiate a tracking area update request message. The Network node 20 then checks if the UE 10 is allowed to receive normal service the area. If so, the network node 20 after completion of the tracking area procedures initiates the bearer establishment for non-emergency PDN. When the UE 10 receives this message, the UE 10 and network node 20 may consider the UE 10's behaviour to be emergency attached.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If the new tracking area identity is detected and the tracking area is not in the forbidden list, the UE 10 may initiate a tracking area update request message and provide an indication that it is requesting for change of UE 10 behaviour from emergency attached to normal attached. The Network node 20 then checks if the UE 10 is allowed to receive normal service the area. If so, the network node 20 sends a tracking area update accept message that informs the UE 10 to change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If the new tracking area identity is detected and the tracking area is not in the forbidden list, the UE 10 may initiate a tracking area update request message and provide an indication that it is requesting for change of UE 10 behaviour from emergency attached to normal attached. The Network node 20 then checks if the UE 10 is allowed to receive normal service the area. If so, the network node 20 sends a tracking area update accept message with an indication that informs the UE 10 to change its behaviour from emergency attached to normal attached. The UE 10 or network node 20 may thereafter initiate bearer establishment for non-emergency PDN.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If the new tracking area identity is detected and the tracking area is not in the forbidden list, the UE 10 may initiate a tracking area update request message and provide an indication that it is requesting for change of UE 10 behaviour from emergency attached to normal attached. The Network node 20 then checks if the UE 10 is allowed to receive normal service the area. If so, the network node 20 after completion of the tracking area procedures initiates the bearer establishment for non-emergency PDN. When the UE 10 receives this message, the UE 10 and network node 20 may consider the UE 10's behaviour to be emergency attached.

According to another embodiment of this invention, a normally attached UE 10 becomes an emergency attached UE 10 when it receives an indication that the UE 10 should consider itself to be emergency attached. The indication is sent in the tracking area update accept message in response to tracking area update request message. The UE 10 then monitors the change in tracking area identity if any. If the new tracking area identity is detected and the tracking area is not in the forbidden list, the UE 10 may initiate a initiate bearer establishment for non-emergency PDN. The Network node 20 then checks if the UE 10 is allowed to receive normal service the area. If so, the network node 20 after completion of the tracking area procedures initiates the bearer establishment for non-emergency PDN. When the UE 10 receives this message, the UE 10 and network node 20 may consider the UE 10's behaviour to be emergency attached.

According to another embodiment of this invention, an emergency attached UE can be triggered to resume normal service when the network detects the end of emergency call. The end of emergency call can typically be achieved either by either be UE triggered (e.g. BYE message) or network triggered (e.g. deactivation of GBR bearers). Network Node may then proceed with detaching the UE with re-attach indication that allows the UE to immediately re-attach thus avoiding both the network node running the inactivity timer or the UE running the periodic timer.

As but some examples, the use of other similar or equivalent messages, number of messages and message contents may be attempted by those skilled in the art. However, all such and similar modifications of this invention will still fall within the scope of this invention. Furthermore, some of the features of the present invention could be used to advantage without the corresponding use of other features. As such, the foregoing description should be considered as merely illustrative of the principles of the present invention, and not in limitation thereof.

1. A system performs resumption of a normal service comprising of:
an user equipment that is capable of using only a limited service after receiving a limited service indication from a network, and sends a behaviour change request message when the user equipment enters a new tracking area with a tracking area identity that is not included in a forbidden list, and
the network that accepts the behaviour change request message and sends a behaviour change accept message when the network receives the behaviour change request message from the user equipment that is currently capable of using only a limited service and sending the behaviour change request message from an area wherein the user equipment can use a normal service.

2. The system of claim 1, wherein the limited service is an emergency service.

3. The system of claim 1, wherein the user equipment after receiving the behaviour change accept message proceeds with bearer handling procedures in order to obtain non-limited bearers.

4. The system of claim 1, wherein the network after transmitting the behaviour change accept message proceeds with bearer handling procedures in order to obtain non-limited bearers.

5. The system of claim 1, wherein the user equipment changes from a state capable of using the normal service to a state capable of using the limited service after receiving the indication by deactivation of non-limited bearers.

6. The system of claim 1, wherein the user equipment changes from being capable of using the normal service to being capable of using the limited service after receiving the indication by TAU accept message.

7. The system of claim 1, wherein the user equipment sends the behaviour change request as a tracking area update request message.

8. The system of claim 1, wherein the network sends a behaviour change request as a tracking area update request message with an explicit indication that informs the user equipment that it is normally attached.

9. The system of claim 1, wherein the network node sends a behaviour change request as a tracking area update request message.

10. The system of claim 1, wherein the user equipment sends a behaviour change request as a PDN connectivity message.

11. The system of claim 1, wherein the network sends a behaviour change request as a default EPS bearer context activation request message.

12. A method for resumption of normal service comprising the steps of:
receiving, at an user equipment, a limited service indication from a network,
changing, at the user equipment, to a state capable of using only a limited service,
sending, from the user equipment, a service change request message when the user equipment enters a new tracking area with a tracking area identity that is not included in a forbidden list,
accepting, at the network, the service change request message and sending a service change accept message when the network receives the service change request message from an area wherein the user equipment can use a normal service.

13. The method of claim 12, wherein the limited service is an emergency service.

14. An user equipment performs resumption of a normal service comprising of:
a reception section that receives a limited service indication, indicating use of only a limited service, from a network, and
a transmission section that transmits a behaviour change request message when the user equipment enters a new tracking area with a tracking area identity that is not included in a forbidden list,
wherein the reception section that further receives a behaviour change accept message from the network.

15. The user equipment of claim 14, wherein the limited service is an emergency service.
